(19) United States
(12) Patent Application Publication
(10) Pub. No.: US 2018/0026846 A1
(43) Pub. Date: Jan. 25, 2018

(54) COMPATIBLE CHANNEL BONDING SERVICE MANAGEMENT

(71) Applicant: QUALCOMM Incorporated, San Diego, CA (US)

(72) Inventors: Gordon Kent Walker, Poway, CA (US); Giridhar Dhati Mandyam, San Diego, CA (US)

(21) Appl. No.: 15/642,753

(22) Filed: Jul. 6, 2017

Related U.S. Application Data
(60) Provisional application No. 62/364,759, filed on Jul. 20, 2016.
(60) Provisional application No. 62/364,177, filed on Jul. 19, 2016.

(51) Int. Cl. H04L 12/24; H04W 72/08; H04W 24/04; H04L 29/08; H04W 72/04

(52) U.S. Cl. CPC H04L 41/0896; H04L 67/16; H04L 69/321; H04W 72/048; H04W 24/04; H04W 72/082

(57) ABSTRACT

A method is described for defining service metadata for multiple RF channel services with no impact to the currently defined service metadata for single tuner receiving devices. One example may include receiving first service layer metadata from a first communication channel and second service layer metadata from a second communication channel; and determining a plurality of services available from the first and second communication channels based on the first and second service layer metadata, wherein at least one of the plurality of services is a multiple channel service that comprises data in a pooled set of the first and second communication channels, wherein the multiple channel service is identified by matching a first service from the first service layer metadata and a second service from the second service layer metadata to identify the at least one of the plurality of service in the pooled set.

### CROSS-REFERENCE TO RELATED APPLICATIONS

This application claims the benefit of U.S. Provisional Patent Application No. 62/364,177, entitled, “COMPATIBLE CHANNEL BONDING SERVICE MANAGEMENT,” filed on Jul. 19, 2016 and U.S. Provisional Patent Application No. 62/364,759, entitled “COMPATIBLE CHANNEL BONDING SERVICE MANAGEMENT,” filed on Jul. 20, 2016, the disclosures of which are hereby incorporated by reference herein in its entirety as if fully set forth below and for all applicable purposes.

### BACKGROUND

### Field

Aspects of the present disclosure relate generally to communication systems, and more particularly, aspects relate to providing channel bonding service management.

### Background

The communication of digital data (e.g., digitized documents, records, databases, audio, video, multimedia, etc.) to, from, and/or between a variety of devices (e.g., computers, cellular telephones, smart phones, personal digital assistants (PDAs), tablet devices, content servers, broadcast stations, etc.) for a variety of uses has proliferated in recent years. For example, even the broadcast of over-the-air television signals has begun implementing the use of digital data communication upon adoption of the Advanced Television Systems Committee (ATSC) standards.

A number of techniques (referred to herein as communication enhancement techniques) may be implemented with respect to digital data communication for providing resilience, reliability, performance improvements, and/or increased throughput. For example, techniques for aggregating or combining channels (collectively referred to herein as channel pooling) for redundancy or increased throughput are provided for in the operation of some communication systems (e.g., carrier aggregation in Long Term Evolution (LTE) cellular communication networks and channel bonding in ATSC broadcast systems). Such channel pooling is an arrangement in which two or more channels (e.g., frequency division channels, time division channels, etc.) in a communication system are combined for data communication, such as to provide redundancy and/or increased throughput in general higher capacity.

Communication enhancement techniques are often implemented, at least in part, at the physical layer. For example, the aforementioned channel pooling techniques implement aggregation or combining of the two or more channels at the physical layer. The digital data communicated using such communication enhancement techniques, however, is often utilized by or at a higher layer, such as a service layer, in the operating environment of the receiving device. For example, middleware operable upon a device receiving the digital data to mediate the data that is available for presentation or use by one or more applications or other agents (e.g., functional modules operable at the application layer) may provide mediation services with respect to data communicated using a technique such as channel pooling (e.g., carrier aggregation or channel bonding).

Accordingly, metadata may be provided both at the physical layer and one or more higher layers (e.g., service layer) to facilitate appropriate operation of the various functional aspects of the devices. For example, functional modules operable at the physical layer, such as transceivers, modems, etc., may utilize physical layer metadata (e.g., physical layer signaling, such as may be provided in a data frame preamble or other low level signaling) to operate in accordance with a communication enhancement technique and functional modules operable at the service layer, such as service definitions (the identification and binding of media streams into user services), may utilize service layer metadata (e.g., service layer signaling, such as may be provided in a service list or other information for discovery and acquisition of services) to operate in accordance with the communication enhancement technique. If such metadata is not provided with respect to a particular layer, the functionality operable at such layers may require adaptation or modification in order to obtain metadata from a different layer (e.g., a module operable at the service layer may require adaptation to “peek” into the physical layer for obtaining metadata regarding a communication enhancement technique and provide the requisite operation), although this is generally considered to be a layering violation. In addition to such cross-layer operation presenting a “layer violation” with respect to some communication protocols (e.g., ATSC), it often being undesirable to adapt or modify functionality for such cross-layer operation (e.g., resulting in non-standards based instances of the functional modules or functional modules that are not standards compliant, requiring adaptation or modification of widely deployed functional modules, etc.).

### SUMMARY

In one aspect of the disclosure, a method for providing communications in a communication system is provided. The method of embodiments may include receiving first service layer metadata from a first communication channel and second service layer metadata from a second communication channel. The method of embodiments may also include determining a plurality of services available from the first communication channel and the second communication channel based, at least in part, on the first service layer metadata and the second service layer metadata, wherein at least one of the plurality of services is a multiple channel service that comprises data in a pooled set of the first communication channel and the second communication channel, and wherein the multiple channel service is identified by examining service layer metadata of the plurality of services for a first service from the first service layer metadata matching a second service from the second service layer metadata.

In an additional aspect of the disclosure, an apparatus for providing communications in a communication system is provided. The apparatus of embodiments may include means for receiving first service layer metadata from a first communication channel and second service layer metadata from a second communication channel. The apparatus of embodiments may also include means for determining a plurality of services available from the first communication channel and the second communication channel based, at least in part, on the first service layer metadata and the second service layer metadata, wherein at least one of the plurality of services is a multiple channel service that comprises data in a pooled set of the first communication channel and the second communication channel, and wherein the multiple channel service is identified by examining service layer metadata of the plurality of services for a first service from the first service layer metadata matching a second service from the second service layer metadata.

In a further aspect of the disclosure, a non-transitory computer-readable medium having program code recorded thereon for providing communications in a communication system is provided. The program code of embodiments may include code for receiving first service layer metadata from a first communication channel and second service layer metadata from a second communication channel. The program code of embodiments may also include code for determining a plurality of services available from the first communication channel and the second communication channel based, at least in part, on the first service layer metadata and the second service layer metadata, wherein at least one of the plurality of services is a multiple channel service that comprises data in a pooled set of the first communication channel and the second communication channel, and wherein the multiple channel service is identified by examining service layer metadata of the plurality of services for a first service from the first service layer metadata matching a second service from the second service layer metadata.

In a still further aspect of the disclosure, an apparatus for providing communications in a communication system is provided. The apparatus of embodiments includes at least one processor, and a memory coupled to the processor. The at least one processor of embodiments of the apparatus may be configured to perform steps including receiving first service layer metadata from a first communication channel and second service layer metadata from a second communication channel. The at least one processor of embodiments of the apparatus may also be configured to perform steps including determining a plurality of services available from the first communication channel and the second communication channel based, at least in part, on the first service layer metadata and the second service layer metadata, wherein at least one of the plurality of services is a multiple channel service that comprises data in a pooled set of the first communication channel and the second communication channel, and wherein the multiple channel service is identified by examining service layer metadata of the plurality of services for a first service from the first service layer metadata matching a second service from the second service layer metadata.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a communication system adapted according to embodiments of the present disclosure.

FIG. 2 shows a graph representing operation under statistical multiplexing according to embodiments of the present disclosure.

FIGS. 3A and 3B show high level flow diagrams of operation of different configurations of receiving devices in a communication system implementing channel bonding according to embodiments of the present disclosure.

FIGS. 4 and 5 and 6 show detail with respect to a portion of the flow of operation of FIG. 3A in operation of different channel bonding techniques according to embodiments of the present disclosure.

FIGS. 7 and 8 are diagrams illustrating receiving device configurations adapted according to embodiments of the present disclosure.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The word “exemplary” is used herein to mean “serving as an example, instance, or illustration.” Any aspect described herein as “exemplary” is not necessarily to be construed as preferred or advantageous over other aspects.

As used in this description, the term “content” may include data having video, audio, combinations of video and audio (e.g., digital multimedia content), or other data at one or more quality levels, the quality level determined by bit rate, resolution, or other factors. The content may also include executable content, such as: object code, scripts, byte code, markup language files, and patches. In addition, “content” may also include files that are not executable in nature, such as documents that may need to be opened or other data files that need to be accessed.

As used in the description herein, the term “receiving device” refers to a wireline and/or wireless communication system at least configured to receive signals (e.g., radio frequency (RF) signals), such as may carry various content to be utilized by one or more devices of or coupled to the receiving device. A receiving device of embodiments may additionally provide for transmission of signals, and thus a receiving device of embodiments may comprise a transceiver device. A receiving device herein may, for example, comprise one or more digital televisions, set top boxes, Digital Video Recorder (DVR), digital direct broadcast systems, wireless broadcast systems, PDAs, laptop or desktop computers, digital cameras, digital recording devices, digital media players, video gaming devices, video game consoles, cellular or satellite radio telephones, video teleconferencing devices, and/or the like.

As used herein, the terms “user equipment,” “user device,” and “client device” include devices capable of receiving content, such as from a server or other source, and may comprise a receiving device, or portion thereof, herein. Such user devices can be stationary devices or mobile devices. The terms “user equipment,” “user device,” and “client device” can be used interchangeably.

As used herein, the term “user” refers to an individual using, accessing, or otherwise associated with the operation of a user device. For example, a user may receive content via a user device or a client device.

Systems and methods disclosed herein provide for the implementation of one or more communication enhancement techniques, such as a channel pooling technique, using metadata or other signaling that is compatible with an existing communication protocol. In accordance with some embodiments, the organization of physical layer and/or service layer metadata that is defined in the protocol is leveraged with respect to a communication enhancement technique, such as a channel pooling technique, to facilitate operation of the communication enhancement technique with multiple different configurations of receiving devices. For example, embodiments allow multiple tuner devices to offer users channel bonded services without requiring new or revised service signaling metadata and allow single RF channel tuners to correctly handle both bonded channel types and other service types expressed on more than one instance of a physical layer. Additional statistical multiplexing gain is available to multiple tuner receivers without impacting performance or operation of single tuner receivers.

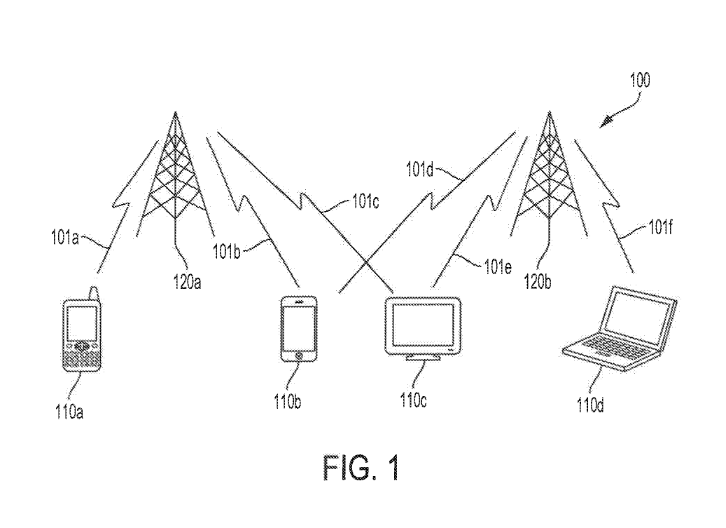

FIG. 1 illustrates communication system 100 adapted for implementing one or more communication enhancement techniques in accordance with concepts herein. Communication system 100 illustrated in FIG. 1 includes multiple devices, such as receiving devices 110a-110d and broadcaster systems 120a-120b, providing for delivery of content via wireless delivery techniques. Receiving devices 110a-110d may comprise any of a number of different user devices, for example, such as digital televisions, set top boxes, DVRs, PDAs, laptop or desktop computers, digital cameras, digital recording devices, digital media players, video gaming devices, video game consoles, cellular or satellite radio telephones, video teleconferencing devices, etc. Broadcaster systems 120a-120b may comprise any number of different transmitting devices, for example, such as digital direct broadcast systems, wireless broadcast systems, etc. Accordingly, receiving devices 110a-110d of the exemplary embodiment are adapted to exchange data via one or more connections 101 (e.g., wireless data communication links provided by one or more ATSC, DVB-T, LTE eMBMS, etc. broadcast systems). For example, receiving device 110a may receive data from and/or transmit data to broadcaster system 120a via connection 101a, receiving device 110b may receive data from and/or transmit data to broadcaster system 120a via connection 101b and broadcaster system 120b via connection 101d, receiving device 110c may receive data from and/or transmit data to broadcaster system 120a via connection 101c and broadcaster system 120b via connection 101e, and receiving device 110d may receive data from and/or transmit data to broadcaster system 120b via connection 101f.

Connections 101 of embodiments may implement various channel allocations, such as to use different frequency bands and/or subcarriers within the frequency bands. For example, broadcaster system 120a may utilize channel allocation A while broadcaster system 120b may utilize channel allocation B, wherein channel allocations A and B may be fully non-overlapping or partially non-overlapping. Correspondingly, various of the links between receiving devices 110 and broadcaster systems 120 may be provided using channels of the respective channel allocations. The RF channel tuners of receiving devices 110 of embodiments are therefore operable to tune to different RF channels of such channel allocations for receiving and/or transmitting data from, to, and between the receiving devices and the broadcaster systems. Some such receiving devices may comprise a single tuner/demodulator configuration capable of tuning to one or more channels of a single channel allocation at any one instance in time, whereas other such receiving devices may comprise a multiple tuner (e.g., two tuner) configuration capable of tuning to one or more channels of multiple channel allocations at any one instance in time.

The devices of communication system 100, or some portion thereof, are adapted to implement one or more communication enhancement techniques in accordance with the concepts herein. For example, where devices of communication system 100 are operable in accordance with ATSC and/or LTE communication protocols, a channel pooling technique (e.g., channel bonding and/or carrier aggregation) may be utilized to provide improved performance, increased throughput, enhanced handoff, etc. The ATSC 3.0 physical layer, for example, defines two modes of Channel Bonding, including Plain Channel Bonding and Signal-to-Noise Ratio (SNR) Channel Bonding (see ATSC Proposed Standard:Physical Layer Protocol (A/322), Doc. S32-230r55, 29 Jun. 2016, the disclosure of which is hereby incorporated herein by reference in its entirety). In addition to channel bonding, which is a physical layer feature, there may be one or more service(s) that requires two tuners, but are not channel bonded or otherwise defined at the physical layer. These require definition at the service layer of the system in order to be supported.

Channels in a wireless communication system, such as LTE or ATSC, may be detected during a channel scan. A channel scan may be performed at device start-up and/or at other times during device operation. For example, a channel scan may be performed at time-based intervals, such as regular intervals during operation of the device. As another example, a channel scan may be performed when a predetermined event occurs, such as when a location of the device is determined to have changed. Each time a channel scan occurs, service metadata may be examined to identify multiple channel services as described in the following examples. In embodiments, described below a method is described for defining service metadata for multiple RF channel services with no impact to the currently defined service metadata for single tuner receiving devices.

The aforementioned Plain Channel Bonding is comprised of a split of a baseband packet stream among two Physical Layer Pipes (PLPs) on different instances of an ATSC 3.0 physical layer on two licensed RF channels. There are provisions for recovering order within the composite baseband stream at the receiver. ATSC currently specifies that the baseband packet stream split between the two PLPs is a maximum 5:1 on a packet count basis with no more than 5 consecutive baseband packets being sent on either instance. In operation, a portion of the data is sent on each frequency of the two RF channels, each of which has a corresponding Bit Stream Identification (BSID) in the service layer metadata. There are no restrictions with respect to the temporal relationship between the respective transmissions other than they are within the same physical layer frame duration, and thus the transmission time of the two portions of data may overlap in time. Accordingly, reception of data communicated using the Plain Channel Bonding mode employs the use of two tuners (e.g., a multiple tuner receiving device configuration). For facilitating object delivery when implementing Plain Channel Bonding according to embodiments, the timing information optionally carried in the packet streams may be the current UTC time at the sender when the last of byte of an object (last layered coding transport (LCT) packet) is emitted/radiated, wherein this labeling is based on the same time base as is used to deliver time in the physical layer.

The aforementioned SNR Channel Bonding combines a maximum of two PLPs on a maximum of two instances of an ATSC 3.0 physical layer on two licensed RF channels. This makes the combined signals more robust than either of the two constituents. In operation, the entire contents of the respective individual PLPs can be received without the use of combining where the signal conditions are suitable with respect one set of the PLPs comprising service. For SNR Channel Bonding, the modulation and coding of the bonded PLPs must be the same. The frame duration of the frames containing the respective PLPs must also be the same. When processing multiple RF channel services configured according to the SNR Channel Bonding protocol, data provided by the multiple channel service may be recovered from the first communication channel and the second communication channel by combining RF representations from the two channels, such as by performing a vector sum prior to a soft decision decoder of a receiving device.

Although the ATSC protocol provides for channel bonding in the physical layer, the services that can be carried at the physical layer are not described by the service signaling provided by the ATSC protocol (see ATSC Candidate Standard: Signaling, Delivery, Synchronization, and Error Protection (A/331), Doc S33-1-500r5, 31 Mar. 2016, Appendix G2, the disclosure of which is hereby incorporated herein by reference in its entirety). Accordingly, embodiments herein provide techniques for services carried via physical layer channel bonding or other multiple physical layer instance service(s) to be understood and implemented at a higher layer (e.g., service layer) via the existing service signaling without changing the existing current defined physical layer or service signaling metadata.

In accordance with an exemplary embodiment implementing channel pooling, the defined organization of service signaling metadata correctly handles all defined configurations of both single and combined channel services without revision of the current service signaling metadata. For example, embodiments implementing ATSC channel bonding operate to use service signaling metadata defined in the ATSC protocol to facilitate communication of both single and combined channel services and/or use of single and multiple tuner receiver devices. Accordingly, such channel pooling techniques may be provided in such a way as to enhance one or more aspects of communications with respect to multiple tuner receiving devices and/or single tuner receiving devices (e.g., improved performance, increased throughput, enhanced handoff, etc.) running in a compatible mode with the existing protocol. In operation according to embodiments, for example, a multiple channel service may be made available to a multiple tuner receiving device in a first communication channel and a second communication channel of pooled channels without affecting reception by a single tuner receiving device of a first service in the first communication channel or a second service of the second communication channel (e.g., a supported single BSID service may be comprised of “essential” components, such as may be provided without the second BISD even though the second BSID may carry other components).

A single tuner receiving device of embodiments operating with respect to the foregoing channel pooling implementation need not read nor understand physical layer metadata related to combined channels in order to provide desired operation of the receiving device. In operation according to embodiments, the service layer signal processing of the single RF channel tuners of such a single tuner receiving device need not be aware of combined channel services at all. Nevertheless, such single tuner receiving devices may benefit from some aspects of a combined channel, such as to implement enhanced service handoff by the single tuner receiving device inspecting the service layer metadata and/or other service layer data for matching services. In accordance with alternative embodiments herein, physical layer metadata may be utilized by the service layer functionality to simplify one or more of the foregoing tasks.

A multiple tuner receiving device of embodiments operating with respect to the foregoing channel pooling implementation can correctly manage the combined channels with no interaction between physical layer and service signaling using appropriately configured service metadata according to concepts herein. For example, where Channel Bonding is utilized in accordance with an ATSC protocol, service signaling may be expressed as the same for the SNR Channel Bonded data on each licensed RF channel. Service signaling may be expressed in a same manner on each licensed RF channel for a Plain Channel Bonded service, such as by identifying each instance of Plain Channel Bonded service as “hidden.” The utilization of the “hidden” attribute and service attribute similarity in accordance with embodiments herein can additionally or alternatively be used for layered services delivered on two licensed RF channel instances of a physical layer. In some embodiments, an attribute already defined in the applicable standard, such as the “@hidden” attribute of the ATSC standard, may be used for indicating layered services, or more generically “multiple channel services.” In other embodiments a new attribute may be added to an applicable standard or implementation of a standard, such as a “@not_single_tuner” attribute, and used for indicating multiple channel services.

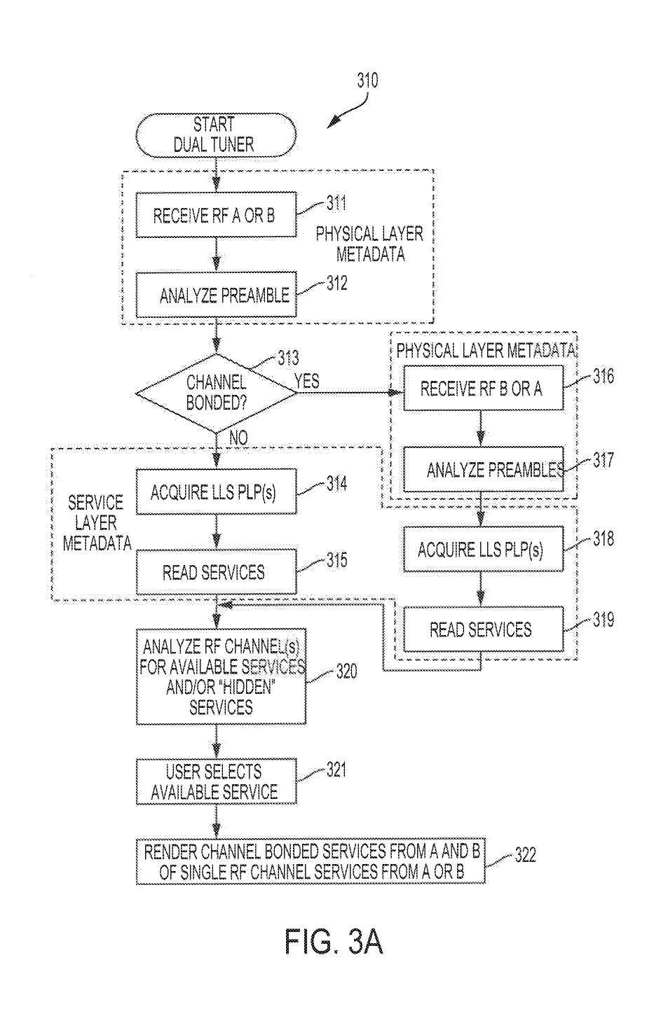

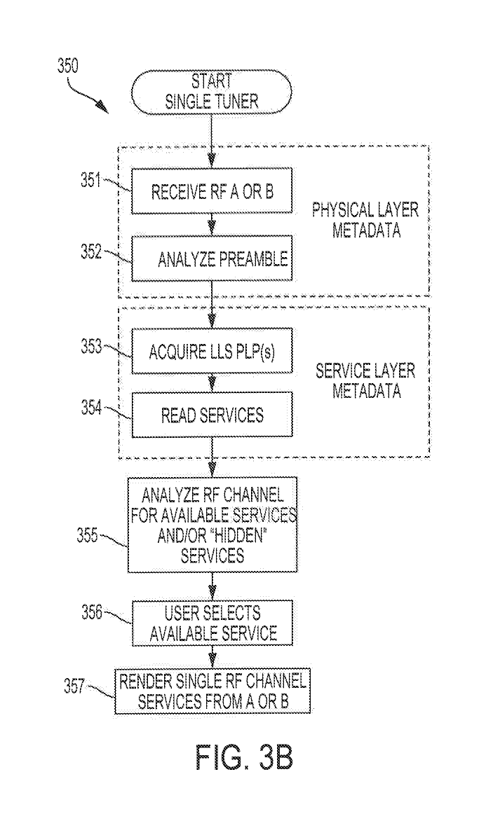

FIGS. 3A and 3B illustrate operation of multiple tuner receiving device configurations (FIG. 3A) and single tuner receiving device configurations (FIG. 3B) of embodiments in accordance with the foregoing. For example, flow 310 of FIG. 3A may be utilized by a multiple tuner receiving device for a communication system implementing Plain Channel Bonding and/or SNR Channel Bonding in accordance with concepts herein. Flow 350 of FIG. 3B may be utilized by a single tuner receiving device for a communication system implementing Plain Channel Bonding and/or SNR Channel Bonding in accordance with concepts herein.

Exemplary use cases, in which a communication enhancement technique is implemented in accordance embodiments of the disclosure, are useful to aid in the understanding of concepts herein. In a first such exemplary use case, assume that broadcaster systems 120a and 120b are operated by licensed RF channel holders that conclude that it makes sense to combine the bandwidth on their two licensed RF allocations in order to maximize the total channel capacity. Thus, in communication system 100 the Plain Channel Bonded channel pooling service of the ATSC protocol is to be implemented with respect to channels of channel allocation A of broadcaster system 120a and channel allocation B of broadcaster system 120b.

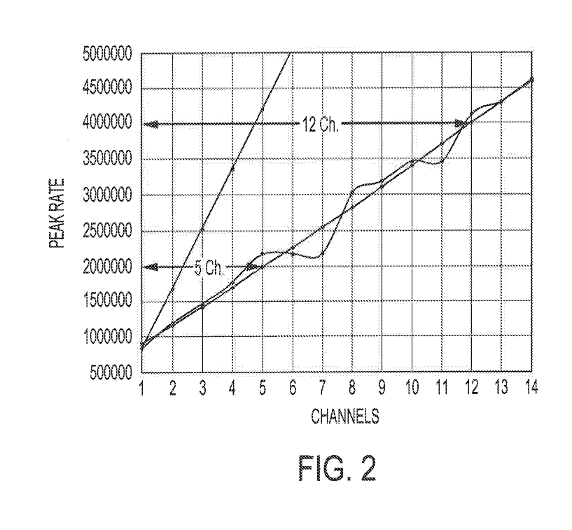

A greater bandwidth operating under statistical multiplexing achieves higher bit rate efficiency, as illustrated in the peak rate verses channel count graph of FIG. 2 (showing example services at 24 fps, 1080 P HEVC Main 10, with 1 second IDR cadence). The required peak bit rate per stream is reduced as the number of video streams increases. In an exemplary configuration of communication system 100, broadcaster systems 120 participating on the two licensed RF channels may, for example, run a total of 12 services at an aggregate rate of 40 Mbps vs. the 5 possible services in 20 Mbps peak. Two groups of five services may run exclusively on one each licensed RF channel (i.e., 5 services on channel allocation A of broadcaster system 120a and 5 services on channel allocation B of broadcaster system 120b) for a total of ten services of the aforementioned total of 12 services. However, at least two services of the 12 services must exist in one or both licensed RF channels as provided by the use of Plain Channel Bonding for the two impacted services. In such a channel pooling implementation, single tuner receiving devices can receive the five services of either channel allocation for which communication is possible (e.g., a single tuner configuration of receiving device 110a can receive the 5 services of channel allocation A transmitted by broadcaster system 120a, a single tuner configuration of receiving device 110b can receive either the 5 services of channel allocation A transmitted by broadcaster system 120a or the 5 services of channel allocation B transmitted by broadcaster system 120b at any particular instance in time, a single tuner configuration of receiving device 110c can receive either the 5 services of channel allocation A transmitted by broadcaster system 120a or the 5 services of channel allocation B transmitted by broadcaster system 120b at any particular instance in time, and a single tuner configuration of receiving device 110d can receive the 5 services of channel allocation B transmitted by broadcaster system 120b). However, receiving the two additional Plain Bonded Channels utilizes a two tuner receiver configuration (e.g., a multiple tuner configuration of receiving device 110b can receive the 5 services of channel allocation A transmitted by broadcaster system 120a, the 5 services of channel allocation B transmitted by broadcaster system 120b, and the 2 services provided by the channel pooling of allocations A and B and a multiple tuner configuration of receiving device 110c can receive the 5 services of channel allocation A transmitted by broadcaster system 120a, the 5 services of channel allocation B transmitted by broadcaster system 120b, and the 2 services provided by the channel pooling of allocations A and B).

As previously discussed, although techniques may be provided for the channel bonding in the physical layer, the service signaling defined in the ATSC protocol does not describe the services that are carried at the physical layer. Accordingly, embodiments herein utilize existing service layer signaling for services carried via physical layer channel bonding in order to facilitate utilization of such services at the service layer (e.g., without a layer violation and without changing the existing physical layer or service signaling metadata). For example, the physical layer channel bonding may be signaled in the physical layer signaling (e.g., such as within a data frame preamble) in order that one or more physical layer functional modules (e.g., the RF channel tuners) may be informed of the Plain Channel Bonding implementation. The service layer signaling with respect to the Plain Channel Bonding may be provided using existing service definitions (e.g., the “hidden” service definition provided for in Service List Tables (SLTs) of ATSC) with respect to the services provided using channel bonding. For example, the two additional Plain Bonded Channels in the foregoing example may each be defined or otherwise designated the same (e.g., each defined as “hidden”) in the service layer signaling for facilitating identifying and understanding by one or more service layer functional modules that the services are available in the bonded channels.

In an embodiment operable to accommodate the foregoing exemplary use case, flow 310 of FIG. 3A and flow 350 of FIG. 3B are utilized to provide operation of multiple tuner receiving device configurations and single tuner receiving device configurations, respectively, with respect to implementations of Plain Channel Bonding according to concepts of the present disclosure. At block 311 of FIG. 3A, a multiple tuner receiving device (e.g., a multiple tuner configuration of receiving device 10b or 110c of FIG. 1) receives an RF channel of allocation A and/or allocation B. Physical layer signaling of the received RF channel (e.g., data frame preambles providing physical layer metadata) is analyzed by logic of the receiving device, at block 312 of the illustrated embodiment, to facilitate extracting the transmitted data and to determine if channel bonding is being implemented. A determination may be made (e.g., based upon information from the analysis of the physical layer signaling) by logic of the receiving device at block 313 regarding whether Plain Channel Bonding is implemented with respect to the received RF channel (e.g., one or more services are transmitted using a split of a baseband packet stream among two PLPs on different instances of a physical layer on two licensed RF channels).

If it is determined at block 313 that Plain Channel Bonding is not implemented with respect to the received RF channel, processing according to the illustrated embodiment proceeds to block 314 wherein information (e.g., service layer metadata) regarding the services provided with respect to the received RF channel is acquired. For example, the LLSs for the PLPs in the received RF channel may be analyzed to determine the services provided where, for example, the LLSs for a RF channel declare the services in a SLT for each BSID. One or more service layer functional modules may use the acquired service information to read the services of the received RF channel, such as for providing a list of available services to the user, for implementing one or more services, etc., at block 315. It should be appreciated that, in the case channel bonding is not implemented, blocks 311, 312, 314, and 315 may nevertheless be performed with respect to RF channels of both allocations A and B in order to utilize services provided in either or both such RF channels.

If, however, it is determined at block 313 that Plain Channel Bonding is implemented with respect to the received RF channel, processing according to the illustrated embodiment proceeds to block 316 wherein the multiple tuner receiving device receives an RF channel of the other one of allocation B or allocation A (i.e., the RF channel for which channel bonding is being implemented with respect to the received channel of block 311). Physical layer signaling of the first and second mentioned received RF channels (e.g., data frame preambles providing physical layer metadata in each of the received RF channels) is analyzed by logic of the receiving device, at block 317 of the illustrated embodiment, to facilitate extracting the transmitted data. Accordingly, at block 318 of the illustrated embodiment information (e.g., service layer metadata) regarding the services provided with respect to the first and second mentioned received RF channels is acquired. For example, the LLSs for the PLPs in both the first mentioned RF channel and the second mentioned RF channel may be analyzed to determine the services provided by each such received RF channel. One or more service layer functional modules may use the acquired service information to read the services of the respective RF channels, such as for providing a list of available services to the user, for implementing one or more services, etc., at block 319.

The services of either or both channel allocation A and channel allocation B as well as the services provided by channel bonding of channel allocation A and channel allocation B may be designated or otherwise determined to be available to a user device associated with the multiple tuner receiving device configuration of the exemplary embodiment. For example, certain duplicate service definitions may be used to signal that one or more services are provided using Plain Channel Bonding. Embodiments herein utilize the “hidden” service attribute of ATSC SLT with respect to a service that is provided using channel bonding (e.g. the LLS(s) SLTs for each received RF channel declare that the two tuner services exist in the SLT for each BSID, but each instance is defined as “hidden” in the SLT on each instance of RF channel). It can be the case that the services which utilize Plain Channel Bonding utilize the same PLP(s) on each BSID. This information may be used as an additional condition for Plain Channel Bonding according to some embodiments herein. For example, the general condition may be that the service is declared the same on both licensed RF channels, possibly including PLP(s) numbers utilized.

Having acquired service layer information regarding the services provided by the first mentioned received RF channel and/or the second mentioned received RF channel, logic of the receiving device may operate to analyze the services for the available services and/or the “hidden” services at block 320. Accordingly, where a duplicate service is present in the service layer information of both the first mentioned received RF channel and each such instance of the service is defined as “hidden”, multiple tuner receiving devices of embodiments herein may understand that these services are not hidden from the users with such multiple tuner receivers when operating with Plain Channel Bonding (i.e., receiving devices capable of receiving the services provided using channel bonding). Where Plain Channel Bonding is not implemented, the services of either or both channel allocation A and channel allocation B that are not defined as “hidden” may be designated or otherwise determined to be available for use by a user device.

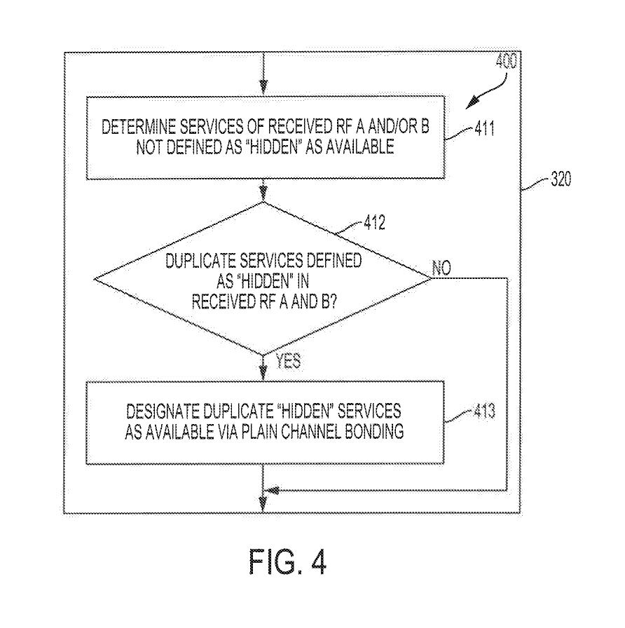

Detail with respect to operation at block 320 of some embodiments implementing Plain Channel Bonding is shown in FIG. 4. In operation of flow 400 of FIG. 4, the service layer information acquired above is analyzed by logic of the receiving device, at block 411, to determine the services of the first mentioned received RF channel and/or second mentioned received RF channel that are not defined as “hidden” to determine services available to the receiving device and/or the user thereof. At block 412 the services of the first mentioned received RF channel and the second mentioned received RF channel are analyzed to determine if duplicate services are defined as “hidden” (e.g., provided by Plain Channel Bonding according to an embodiment herein). Services may be identified as duplicates based on a combination of @serviceId, provider_id, @majorChannelNo, and/or @minorChannelNo number. In one embodiment, a combination of @serviceId and provider_id may be used to determine if two services from different RF channels are matches for a multiple channel service. In other embodiments, other combinations of @serviceId, provider_id, @majorChannelNo, and @minorChannelNo may be used to determine if two services from different RF channels are matches for a multiple channel service. If no duplicate services are defined as “hidden” (e.g., Plain Channel Bonding is not implemented), processing according to the illustrated embodiment proceeds to exit processing of block 320 (e.g., proceeding to block 321 of FIG. 3). However, if duplicate services are defined as “hidden” (e.g., Plain Channel Bonding is implemented), processing according to the illustrated embodiment proceeds to block 413. At block 413 the duplicate services defined as “hidden” are designated as available via Plain Channel Bonding according to the illustrated embodiment, and processing proceeds to exit processing of block 320 (e.g., proceeding to block 321 of FIG. 3).

As can be appreciated from the foregoing, using the service layer information acquired above, embodiments herein may determine the services available to the receiving device and/or the user thereof. Accordingly, where Plain Channel Bonding is not implemented, the services of either or both channel allocation A and channel allocation B may be presented to the user (e.g., in a channel guide displayed on a user device) for selection of desired one or more of the available services at block 321. Where Plain Channel Bonding is implemented, the services of either or both channel allocation A and channel allocation B as well as the services provided by channel bonding may be presented to the user (e.g., in a channel guide displayed on a user device) for selection of desired one or more of the available services at block 321. Accordingly, at block 322 of the illustrated embodiment, a selected Plain Channel Bonded service from channel allocations A and B or a single RF channel service from channel allocation A or B may be rendered.

Referring now to FIG. 3B, flow 350 shows exemplary operation of single tuner receiving device configurations utilizing the foregoing signaling with respect to Plain Channel Bonding. At block 351 of FIG. 3B, a single tuner receiving device (e.g., a single tuner configuration of receiving device 110a, 110b, 110c, or 110d of FIG. 1) receives an RF channel of allocation A or allocation B. Physical layer signaling of the received RF channel (e.g., data frame preambles providing physical layer metadata) is analyzed by logic of the receiving device, at block 352 of the illustrated embodiment, to facilitate extracting the transmitted data. At block 353 information (e.g., service layer metadata) regarding the services provided with respect to the received RF channel is acquired. For example, the LLSs for the PLPs in the received RF channel may be analyzed to determine the services provided where, for example, the LLSs for a RF channel declare the services in a SLT for each BSID. One or more service layer functional modules may use the acquired service information to read the services of the received RF channel, such as for providing a list of available services to the user, for implementing one or more service, etc., at block 354.

The services of either channel allocation A or channel allocation B may be designated or otherwise determined to be available to a user device associated with the single tuner receiving device configuration of the exemplary embodiment. Having acquired service layer information regarding the services provided by the received RF channel, logic of the receiving device may operate to analyze the services for the available services and/or the “hidden” services at block 355. For example, the service information may be analyzed to determine if any services are defined as “hidden”, which is an attribute that for a single tuner receiving device of embodiments means the service is not offered to the user (e.g., a service provided using Plain Channel Bonding such that two or more receivers are needed to receive the data of the service). Where Plain Channel Bonding is implemented, the services provided by Plain Channel Bonding may be defined as “hidden” in the RF channels of each of channel allocation A and channel allocation B according to embodiments, and thus determined not to be available for use by the single receiving device configuration receiving either such RF channel. Accordingly, the services of the received RF channel (e.g., RF channel of either channel allocation A or channel allocation B) may be presented to the user (e.g., in a channel guide displayed on a user device) for selection of desired one or more of the available services at block 356, while the services provided by Plain Channel Bonding are not presented to the user. At block 357 of the illustrated embodiment, a selected single RF channel service from channel allocation A or B may be rendered.

Embodiments operable in accordance with the foregoing exemplary flows of FIGS. 3A, 3B, and 4 may be utilized to provide increased capacity via selective assignment of services to single licensed RF channel delivery and Plain Bonded Channel delivery with no impact to defined service signaling metadata. In facilitating the foregoing, the application rule for signaling metadata to enable Plain Channel Bonded services of embodiments provides for duplication of service metadata on each licensed RF channel for bonded channels and the use of the hidden attribute, wherein both instances of a service labeled as “hidden” denotes a Plain Channel Bonded service. This technique provides for transparent operation of single tuner receivers for Plain Channel Bonded services. For example, all linear TV services not marked as “hidden” may be provided to the user and are decodable with a single tuner as the sole resource.

In the foregoing operation, a multiple tuner receiving device understands that the Plain Channel Bonded services defined as “hidden” are not hidden from the users with the multiple tuner receiving devices, when operating with Plain Channel Bonding. It should be appreciated that actual single tuner hidden services do not run Plain Channel Bonding, so there is no loss of function in operation of the foregoing embodiments. Thus, the potential efficiency gain achieved by a doubling of total accessible baseband bandwidth by statistical multiplexing is achieved for the two tuner receivers, while not adversely impacting the single tuner implementation. This is a significant advantage as compared to all receivers having to understand and implement two tuner operation in order to achieve any capacity increase.

As another exemplary use case, assume that broadcaster systems 120a and 120b are operated by licensed RF channel holders that conclude that it makes sense to combine the radiated energy from their respective transmitters for multiple tuner receiving devices due to different macro shadowing for their respective transmitter sites. For example, there may be three major valleys in the market, but neither station's transmitter can cover more than two out of the three valleys from their respective primary transmitter. However, the combined coverage reaches all three valleys. Accordingly, common services may be implemented with SNR Channel Bonding.

In operation of a communication system implementing SNR Channel Bonding, single tuner receiving devices may receive service on designated PLPs from either BSID. However, two tuner receiving devices can combine the energy received from each transmitter for the SNR Channel Bonded services (another kind of “multiple channel service”). As discussed above, the service signaling defined in the ATSC protocol does not describe the services that are carried at the physical layer. Accordingly, embodiments herein utilize existing service layer signaling for services carried via physical layer channel bonding in order to facilitate utilization of such services at the service layer (e.g., without a layer violation and without changing the existing physical layer or service signaling metadata). For example, the physical layer channel bonding may be signaled in the physical layer signaling (e.g., within a data frame preamble) in order that one or more physical layer functional modules (e.g., the RF channel tuners) may be informed of the SNR Channel Bonding implementation. The service layer signaling with respect to the SNR Channel Bonding may be provided by declaring that the same common services exist in the SLT for each BSID.

In an embodiment operable to accommodate the foregoing exemplary use case, flow 310 of FIG. 3A and flow 350 of FIG. 3B are utilized to provide operation of multiple tuner receiving device configurations and single tuner receiving device configurations, respectively, with respect to implementations of SNR Channel Bonding according to concepts of the present disclosure. At block 311 of FIG. 3A, a multiple tuner receiving device (e.g., a multiple tuner configuration of receiving device 110b or 110c of FIG. 1) receives an RF channel of allocation A and/or allocation B. Physical layer signaling of the received RF channel (e.g., data frame preambles providing physical layer metadata) is analyzed by logic of the receiving device, at block 312 of the illustrated embodiment, to facilitate extracting the transmitted data and to determine if channel bonding is being implemented. A determination may be made (e.g., based upon information from the analysis of the physical layer signaling) by logic of the receiving device at block 313 regarding whether SNR Channel Bonding is implemented with respect to the received RF channel (e.g., two PLPs are combined on two instances of an ATSC 3.0 physical layer on two licensed RF channels).

If it is determined at block 313 that SNR Channel Bonding is not implemented with respect to the received RF channel, processing according to the illustrated embodiment proceeds to block 314 wherein information (e.g., service layer metadata) regarding the services provided with respect to the received RF channel is acquired. For example, the LLSs for the PLPs in the received RF channel may be analyzed to determine the services provided where, for example, the LLSs for a RF channel declare the services in a SLT for each BSID. One or more service layer functional modules may use the acquired service information to read the services of the received RF channel, such as for providing a list of available services to the user, for implementing one or more services, etc., at block 315. It should be appreciated that, in the case channel bonding is not implemented, blocks 311, 312, 314, and 315 may nevertheless be performed with respect to RF channels of both allocations A and B in order to utilize services provided in either or both such RF channels.

If, however, it is determined at block 313 that SNR Channel Bonding is implemented with respect to the received RF channel, processing according to the illustrated embodiment proceeds to block 316 wherein the multiple tuner receiving device receives an RF channel of the other one of allocation B or allocation A (i.e., the RF channel for which channel bonding is being implemented with respect to the received channel of block 311). Physical layer signaling of the first and second mentioned received RF channels (e.g., data frame preambles providing physical layer metadata in each of the received RF channels) is analyzed by logic of the receiving device, at block 317 of the illustrated embodiment, to facilitate extracting the transmitted data. Accordingly, at block 318 of the illustrated embodiment information (e.g., service layer metadata) regarding the services provided with respect to the first and second mentioned received RF channels is acquired. For example, the LLSs for the PLPs in both the first mentioned RF channel and the second mentioned RF channel may be analyzed to determine that the LLS(s) for each licensed RF channel declare that the same common services exist in the SLT for each BSID (e.g., the descriptions are the same, excluding the unique BSIDs, possibly including the same utilized PLP(s)). One or more service layer functional modules may use the acquired service information to read the services of the respective RF channels, such as for providing a list of available services to the user, for implementing one or more services, etc., at block 319.

The services as provided by either or both channel allocation A and channel allocation B may be designated or otherwise determined to be available to a user device associated with the multiple tuner receiving device configuration of the exemplary embodiment. For example, service definitions of the first mentioned received RF channel and of the second mentioned received RF channel declaring the same services may be used to signal that one or more such services are provided using SNR Channel Bonding. Having acquired service layer information regarding the services provided by the first mentioned received RF channel and/or the second mentioned received RF channel, logic of the receiving device may operate to analyze the services for the available services and/or the “hidden” services at block 320. Accordingly, where a duplicate service is present in the service layer information of both the first and second received RF channels and neither such instance of the service is defined as “hidden”, multiple tuner receiving devices of embodiments herein may understand that these services are available to users with SNR Channel Bonding (i.e., receiving devices capable of receiving the services provided using channel bonding). Where SNR Channel Bonding is not implemented, the services of either or both channel allocation A and channel allocation B that are not defined as “hidden” may be designated or otherwise determined to be available for use by a user device.

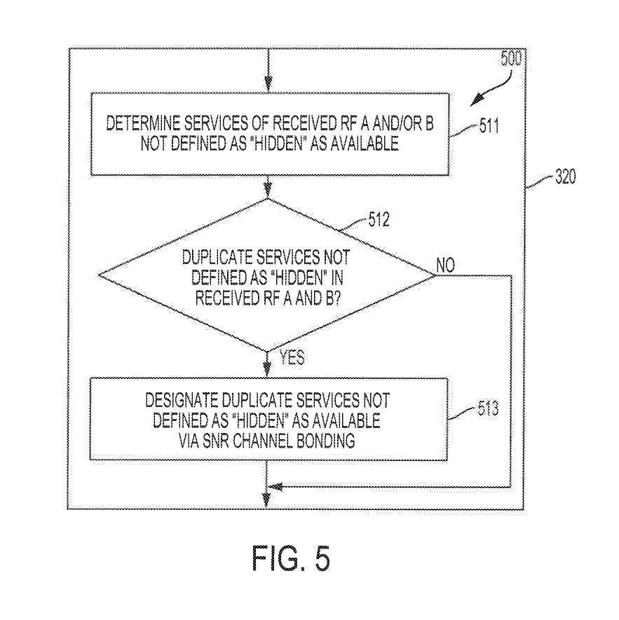

Detail with respect to operation at block 320 of some embodiments implementing SNR Channel Bonding is shown in FIG. 5. In operation of flow 500 of FIG. 5, the service layer information acquired above is analyzed by logic of the receiving device, at block 511, to determine the services of the first mentioned received RF channel and/or second mentioned received RF channel that are not defined as “hidden” to determine services available to the receiving device and/or the user thereof. At block 512 the services of the first mentioned received RF channel and the second mentioned received RF channel are analyzed to determine if duplicate services are provided in the two received RF channels that are not defined as “hidden” (e.g., provided by SNR Channel Bonding according to an embodiment herein). If no duplicate services are present that are not defined as “hidden” (e.g., SNR Channel Bonding is not implemented), processing according to the illustrated embodiment proceeds to exit processing of block 320 (e.g., proceeding to block 321 of FIG. 3). However, if duplicate services are present that are each not defined as “hidden” (e.g., SNR Channel Bonding is implemented), processing according to the illustrated embodiment proceeds to block 513. At block 513 the duplicate services that are not defined as “hidden” are designated as available via SNR Channel Bonding according to the illustrated embodiment, and processing proceeds to exit processing of block 320 (e.g., proceeding to block 321 of FIG. 3).

As can be appreciated from the foregoing, using the service layer information acquired above, embodiments herein may determine the services available to the receiving device and/or the user thereof. Accordingly, services of either or both channel allocation A and channel allocation B may be presented to the user (e.g., in a channel guide displayed on a user device) for selection of desired one or more of the available services at block 321, wherein if SNR Channel Bonding is implemented the services common to both channel allocation A and channel allocation B may be received using receiver combining techniques to provide more robust signals than either of the two constituents. At block 322 of the illustrated embodiment, a selected SNR Channel Bonded service from channel allocations A and B or a single RF channel service from channel allocation A or B may be rendered. In some embodiments, a multiple tuner receiving device may be configured to carry out hard handovers between channel allocations A and B. That is, if either of channel allocations A and B become too noisy or otherwise undecodable, then the multiple tuner receiving device may switch to using the other of the channel allocations A and B. Or, if either of channel allocations A and B become too noisy or otherwise undecodable during multiple channel service operation, then the multiple tuner receiving device may switch to using only one of the channel allocations, and in particular the stronger of the two channel allocations.

Referring to FIG. 3B, flow 350 shows exemplary operation of single tuner receiving device configurations utilizing the foregoing signaling with respect to SNR Channel Bonding. At block 351 of FIG. 3B, a single tuner receiving device (e.g., a single tuner configuration of receiving device 110a, 110b, 110c, or 110d of FIG. 1) receives an RF channel of allocation A or allocation B. Physical layer signaling of the received RF channel (e.g., data frame preambles providing physical layer metadata) is analyzed by logic of the receiving device, at block 352 of the illustrated embodiment, to facilitate extracting the transmitted data. At block 353 information (e.g., service layer metadata) regarding the services provided with respect to the received RF channel is acquired. For example, the LLSs for the PLPs in the received RF channel may be analyzed to determine the services provided where, for example, the LLSs for a RF channel declare the services in a SLT for each BSID. One or more service layer functional modules may use the acquired service information to read the services of the received RF channel, such as for providing a list of available services to the user, for implementing one or more service, etc., at block 354.

The services of either channel allocation A or channel allocation B may be designated or otherwise determined to be available to a user device associated with the single tuner receiving device configuration of the exemplary embodiment. Having acquired service layer information regarding the services provided by the received RF channel, logic of the receiving device may operate to analyze the services for the available services and/or the “hidden” services at block 355. Accordingly, the services of the received RF channel (e.g., RF channel of either channel allocation A or channel allocation B) may be presented to the user (e.g., in a channel guide displayed on a user device) for selection of desired one or more of the available services at block 356. It should be appreciated that the services provided by SNR Channel Bonding, although not available to the single tuner receiving device as a SNR Channel Bonded RF channel, may nevertheless be presented to the user as available services (i.e., as a single FR channel service from channel allocation A or B). At block 357 of the illustrated embodiment, a selected single RF channel service from channel allocation A or B may be rendered.

It should be appreciated that the operation of SNR Channel Bonding may execute so called “soft handoff” in light of both instances of the PLPs containing service can be in concurrent reception. For a single tuner receiving device, the receiver must execute a so called “hard handoff” because the receiver can only be in reception of one licensed RF channel at a time and there is no assurance that the time of delivery at the physical layer is not at the same time. However, the same definition of the PLP format is provided according to embodiments, and thus the single tuner receiving device may identify the handoff candidate by comparison of the SLT for the respective RF licensed channels (e.g., the definitions may be the same except for the BSID), although a match of same PLP and same @majorChannelNo and @minorChannelNo may also be used to indicate bonded services or match of SLT attributes provider_id and @service_id

Embodiments operable in accordance with the foregoing exemplary flows of FIGS. 3A, 3B, and 5 may be utilized to provide service signaling for SNR Channel Bonded services with no impact to service signaling metadata definition. In facilitating the forgoing, the application rule for signaling metadata to enable SNR Channel Bonded services according to embodiments provides for duplication of service metadata on each licensed RF channel for bonded channels. This technique provides for transparent operation of single tuner receivers for SNR Channel Bonded services (e.g., all linear TV services not marked as “hidden” are available to the user). Moreover, the technique implemented according to embodiments may provide for simplified detection of handover candidates via use of physical layer metadata (e.g., the physical layer metadata directly identifies the other licensed RF channel instance for bonded channels, whereas the service level must compare service definitions across the various BSIDs).

Although operation of the flows of FIGS. 3A and 3B have been described separately with respect to implementation of Plain Channel Bonding and SNR Channel Bonding, it should be understood that both such channel bonding technique may be provided for in the operation of the communication system. Accordingly, functionality described above with respect to Plain Channel Bonding (e.g., the functions of FIG. 4) and with respect to SNR Channel Bonding (e.g., the functions of FIG. 5) may be performed in parallel to accommodate implementation of Plain Channel Bonding and SNR Channel Bonding in the communication system.

Exemplary embodiments have been described above with reference to communication enhancement techniques implementing channel bonding (e.g., Plain Channel Bonding and/or SNR Channel Bonding). However, it should be appreciated that the communication enhancement techniques facilitated according to embodiments herein are not limited to channel bonding. For an exemplary use case of a multiple tuner service other than channel bonding, assume two licensed RF channel holders decide that it makes sense to carry their HD service on Ultra High Frequency (UHF) and the Scalable High Efficiency Video Coding (SHVC) layer supporting Ultra High Definition (UHD) reception or other enhancement on a separate, for example Very High Frequency (VHF), channel. This is possibly because the UHF service is targeted at both fixed and mobile reception, while the VHF service may be restricted to fixed reception due to antenna dimensions. The HD or other base (e.g., SD) service may be signaled in the same manner as any non-layered service, except with respect to the MPD (e.g., which may be conformant with Guidelines for Implementation: DASH-IF Interoperability Points for ATSC 3.0, Jul. 12, 2016 DASH Industry Forum, the disclosure of which is hereby incorporated by reference in its entirety, or a subsequent revision).

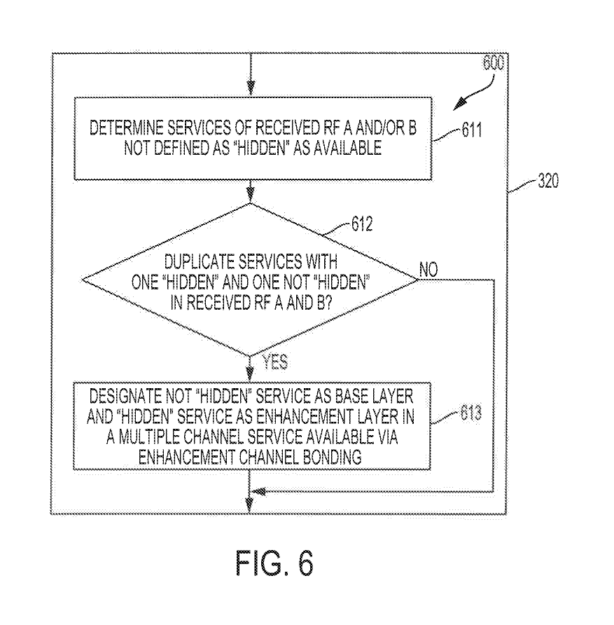

Detail with respect to operation at block 320 of some embodiments implementing Service Layer Enhancement is shown in FIG. 6. In operation of flow 600 of FIG. 6, the service layer information acquired above is analyzed by logic of the receiving device, at block 611, to determine the services of the first mentioned received RF channel and/or second mentioned received RF channel that are not defined as “hidden” to determine services available to the receiving device and/or the user thereof. At block 612 the services of the first mentioned received RF channel and the second mentioned received RF channel are analyzed to determine if duplicate services are defined with one service as “hidden” and with one service as not “hidden”. Services may be identified as duplicates based on a combination of @serviceId, provider_id, @majorChannelNo, and/or @minorChannelNo. In one embodiment, a combination of @serviceId and provider_id may be used to determine if two services from different RF channels are matches for a multiple channel service. In other embodiments, other combinations of @serviceId, provider_id, @majorChannelNo, and @minorChannelNo may be used to determine if two services from different RF channels are matches for a multiple channel service. If no duplicate services are defined, processing according to the illustrated embodiment proceeds to exit processing of block 320. However, if duplicate services are defined with mixed “hidden” and not “hidden” attributes (e.g., Service Layer Enhancement is implemented), processing according to the illustrated embodiment proceeds to block 613. At block 613 the duplicate services defined as “hidden” and not “hidden” are designated as available via Service Layer Enhancement according to the illustrated embodiment, and processing proceeds to exit processing of block 320.

In operation according to embodiments herein, the VHF enhancement bearing PLP may utilize the same L1D_plp_id value and the general service attributes are the same (e.g., provider_id, @serviceId, @majorChannel, and @minorChannelNo). As with the Plain Channel Bonded services above, the HD to UHD or other enhanced format layer may be marked as “hidden” in the SLT delivered to the second of the two tuners. Detection of the presence of such services may be as described above, wherein the match of the service parameters/attributes and the “hidden” attribute indicates that the there is a binding between the two services. Single tuner receiving devices cannot offer the service when in receipt of only the “hidden” layer. It is possible, however, to profile the operation of the respective physical layer such that a single tuner receiving device may receive both layers. For example, the enhancement layer may be found in a temporally disjoint physical layer frame on the “hidden” service under a second BSID. The single tuner receiving device may identify the presence of duplicate provider_id and service during channel scan. If the non-overlapping requirement is not observed, the L1D_plp_id will not match. The opposite convention could also be used. The match of service attributes is sufficient to identify that the enhancement layer is related according to embodiments. It is also reasonable to add an @related service attribute, rather than entirely depending on the use of @hidden, although the use of hidden is enabling an unaware single tuner receiving device of embodiments to behave correctly with respect to this exemplary communication enhancement technique.

It should be appreciated that the foregoing exemplary non-channel bonded use case essentially uses the hidden service attribute technique discussed above with respect to Plain Channel Bonding and the comparison of service definition attributes (and possibly the common L1D_plp_id), but extends that concept to allow identification of Time Division Multiplex (TDM) orthogonality between the BSIDs on a frame basis. It may be desirable to optionally restrict the respective instances of the physical layer to block interleaving according to some embodiments.

The foregoing provides service signaling for enhancement layer via second physical layer instance with no impact to service signaling metadata definition. In facilitating the foregoing, the application rule for signaling metadata to enable second physical layer instance enhancement delivery according to embodiments provides for duplication of service metadata on each licensed RF channel for paired licensed channels. This technique provides for transparent operation of single receiver for two instance enhancement layer (e.g., all single tuner receivers provide linear TV service that is not marked as hidden).

Additionally or alternatively, the foregoing provides for identifying orthogonal TDM of base and enhancement licensed RF instances based on physical layer metadata, when layered service is present. In operation according to embodiments, match of L1D_plp_id indicates time orthogonality is assured or mismatch of L1D_plp_id indicates time orthogonality is assured. Where an enhanced layered service is optionally flagged by @related, which is ignored by ignorant receivers, the use of the “hidden” attribute, as described above, may be utilized to provide appropriate service layer signaling. In operation according to embodiments, the parameter L1D_rf_id from the physical layer may be substituted for BSID from service layer metadata, although this employs the use of physical layer metadata.

Embodiments described above may match services between different communications channels by comparing service layer metadata (e.g., BSID, service ID, provider ID, major and/or minor channel number, etc., and combinations thereof) to identify multiple channel services that implement a service split between multiple communications channels. Another approach may be to recognize multiple channel services by examining capability codes within the service layer metadata. The purpose of capability code signaling is to let the receiver know that certain capabilities are required for it to be able to make a meaningful presentation of the transmitted service. Including a capability code in the signaling may allow a broadcaster way to instruct a certain class of receiving devices to not offer a service unless the receiver has this capability. For example, for plain channel bonding each instance of service (e.g., both BSIDs in an ATSC communications system) may carry a capability code that denotes “Plain Channel Bonding.” As another example, for SNR channel bonding each instance of service (e.g., both BSIDs in an ATSC communications system) may carry a capability code that denotes “SNR Channel Bonding.” As a further example in an ATSC communication system, for a second frequency enhancement the BSID with no base, but including an enhancement layer, may carry a capability code that denotes “Contains Enhancement Layer or Enhancement Layer Only” on the service containing the enhancement data. Although in some cases, this may not be needed if base and enhancement are both present on the same frequency.

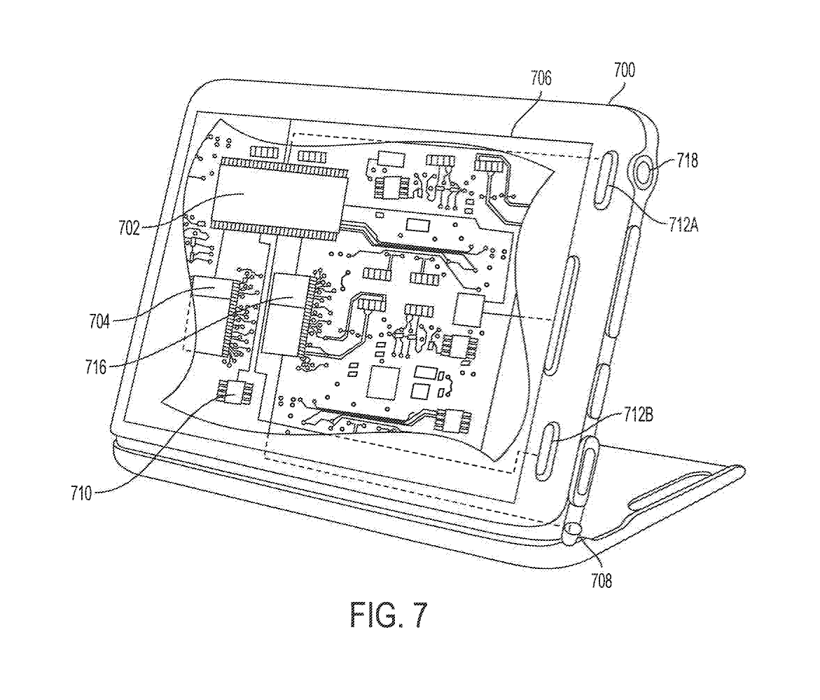

Having described operation to provide communication enhancement techniques in accordance with concepts of the present disclosure, it should be understood that embodiments of the receiving devices may be implemented in various configurations. FIGS. 6 and 7 illustrate exemplary embodiments of user devices in which configurations of receiving devices operable in accordance with the concepts herein may be utilized.

A mobile device (e.g., smart phone, tablet device, PDA, laptop computer, etc.) configuration of a user device as may implement a multiple tuner receiving device or single tuner receiving device operable in accordance with the concepts herein is illustrated in FIG. 7. Mobile device 700 may, for example, include processor 702 (e.g., operable to execute logic providing functionality of a receiving device herein or portions thereof) coupled to internal memories 704 and 710 (e.g., operable to store one or more instruction sets providing logic executed by processor 702). Internal memories 704 and 710 may be volatile or non-volatile memories, and may also be secure and/or encrypted memories, or unsecure and/or unencrypted memories, or any combination thereof. Processor 702 may also be coupled to touch screen display 706, such as a resistive-sensing touch screen, capacitive sensing touch screen infrared sensing touch screen, or the like. It should be appreciated, however, that the display of mobile device 700 need not have touch screen capability. Additionally, mobile device 700 may have one or more antennas 708 for sending and receiving electromagnetic radiation that may be connected to one or more transceivers 716 of a receiving device, such as a wireless data link and/or cellular (e.g., CDMA, TDMA, GSM, PCS, 3G, 4G, LTE, or any other type) transceiver, coupled to processor 702. Mobile device 700 may also include physical buttons 712a and 712b for receiving user inputs. Mobile device 700 may also include a power button 718 for turning mobile device 700 on and off.

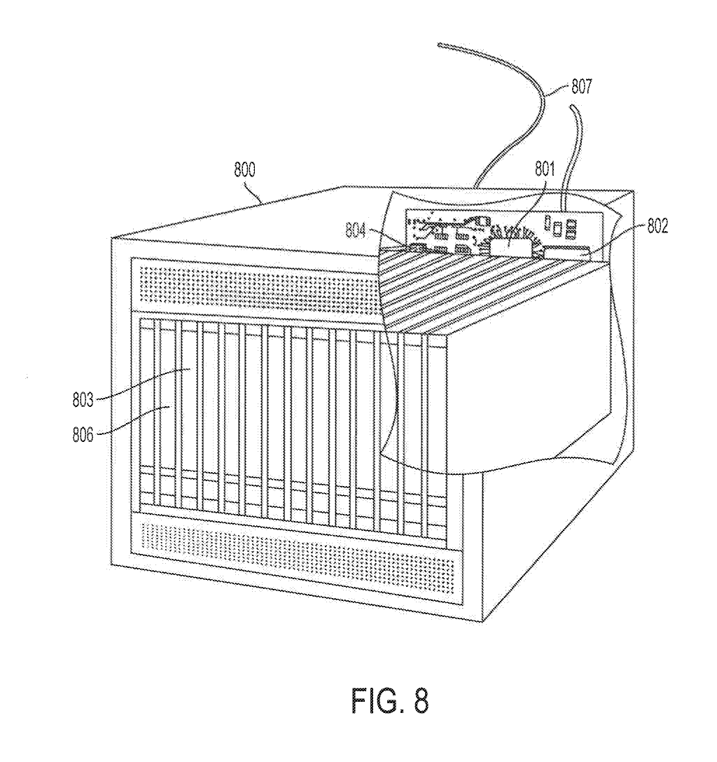

A premise equipment (e.g., personal computer, server, set-top-box, etc.) configuration of a user device as may implement a multiple tuner receiving device or single tuner receiving device operable in accordance with the concepts herein is illustrated in FIG. 8. Premise equipment 800 may, for example, include processor 801 coupled to volatile memory 802 and a large capacity nonvolatile memory, such as disk drive 804. Premise equipment 800 may also include compact disc (CD) or DVD disc drive 806 and/or other nonvolatile memory coupled to processor 801. Premise equipment 800 may also include one or more transceivers 803 of a receiving device, such as a network access port, coupled to processor 801 for establishing network interface connections with communication network 807, such as may comprise the Internet, a LAN, a MAN, a WAN, the public switched telephone network (PSTN), a cellular network (e.g., CDMA, TDMA, GSM, PCS, 3G, 4G, LTE, or any other type of cellular network), etc.

Processors 702 and 801 may be any programmable microprocessor, microcomputer or multiple processor chip or chips that can be configured by software instructions (applications) to perform a variety of functions, including the functions of the various embodiments described above. For example, processors 702 and 801 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor utilized according to embodiments herein may also be implemented as a combination of computing devices (e.g., a combination of a DSP and a microprocessor, a plurality of microprocessors, one or more microprocessors in conjunction with a DSP core, or any other such configuration). In some devices, multiple processors may be provided, such as one processor dedicated to wireless communication functions and one processor dedicated to running other applications.

Typically, software applications may be stored in the internal memory 704, 710, 802, and/or 804 before they are accessed and loaded into processors 702 and 801. For example, a software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal. Processors 702 and 801 of embodiments may include internal memory sufficient to store the application software instructions. In many devices the internal memory may be a volatile or nonvolatile memory, such as flash memory, or a mixture of both. For the purposes of this description, a general reference to memory refers to memory accessible by processors 702 and 801 including internal memory or removable memory plugged into the device and memory within processors 702 and 801 themselves.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for providing communications in a communication system, the method comprising:
receiving first service layer metadata from a first communication channel and second service layer metadata from a second communication channel; and
determining a plurality of services available from the first communication channel and the second communication channel based, at least in part, on the first service layer metadata and the second service layer metadata, wherein at least one of the plurality of services is a multiple channel service that comprises data in a pooled set of the first communication channel and the second communication channel, and wherein the multiple channel service is identified by examining service layer metadata of the plurality of services for a first service from the first service layer metadata matching a second service from the second service layer metadata.

2. The method of claim 1, wherein the pooled set of the first communication channel and the second communication channel comprises a split of a baseband packet stream of the multiple channel service among two physical layer pipes on the first communication channel and the second communication channel.

3. The method of claim 1, further comprising:
matching the first service and the second service by detecting a same service layer service attribute in both the first communication channel and the second communication channel.

4. The method of claim 3, wherein detecting a same service layer service attribute in both the first communication channel and the second communication channel comprises detecting a different BSID and detecting a same at least one other service layer service attribute.

5. The method of claim 3, wherein the first communication channel comprises a baseband packet stream of the first service and the second communication channel comprises a baseband packet stream of the second service, and wherein a multiple tuner receiving device is operable to make any or all of the first service, the second service, and the multiple channel service available to a user at a same instant in time based at least in part on the service layer service attribute.

6. The method of claim 5, wherein a single tuner receiving device is operable to make either the first service or the second service available to a user at an instant in time, and wherein the single tuner receiving device is operable to not make a third service available to the user at the instant in time based at least in part on the service layer service attribute.

7. The method of claim 1, wherein the pooled set of the first communication channel and second communication channel is provided at a physical layer using a Plain Channel Bonding protocol.

8. The method of claim 1, wherein the multiple channel service is made available to a multiple tuner receiving device in the first communication channel and the second communication channel without affecting reception, by a single tuner receiving device, of the first service in the first communication channel or the second service of the second communication channel.

9. The method of claim 8, wherein a channel capacity of a combination of the first communication channel and the second communication channel is larger than a channel capacity of the first communication channel and the second communication channel separately.

10. The method of claim 1, wherein the pooled set of the first communication channel and second communication channel is formed by combining a first RF representation of the first communication channel and a second RF representation of the second communication channel.

11. The method of claim 10, further comprising:
detecting the pooled set of the first communication channel and second communication channel by detecting duplication of service layer data with respect to the multiple channel service in both the first communication channel and the second communication channel.

12. The method of claim 11, wherein the pooled set of the first communication channel and second communication channel is implemented at a physical layer, and wherein detecting the multiple channel service uses the duplication of service layer data with respect to the multiple channel service without using physical layer data.

13. The method of claim 11, wherein the multiple channel service is also available by receiving either the first or second communication channels.

14. The method of claim 11, wherein the first communication channel comprises a first RF representation of a portion of the multiple channel service and the second communication channel comprises a second RF representation of a portion of the multiple channel service, wherein a multiple tuner receiving device is operable to make the multiple channel service available to a user from data received from the first communication channel, the second communication channel, or the pooled set of the first communication channel and second communication channel.

15. The method of claim 14, wherein a single tuner receiving device is operable to make the multiple channel service available to a user from data received from the first communication channel or the second communication channel alone.

16. The method of claim 10, wherein a multiple tuner received device is operable to switch between the first communication channel and the second communication channel of the multiple channel service when a failure of one of the first communication channel or the second communication channel occurs.

17. The method of claim 10, wherein the pooled set of the first communication channel and second communication channel is provided at a physical layer using a SNR Bonding method.

18. The method of claim 1, wherein the pooled set of the first communication channel and the second communication channel comprises a split of a media stream of the multiple channel service, wherein first data of the first communication channel of the multiple channel service is a base layer, and wherein second data of the second communication channel of the multiple channel service is an enhancement layer.

19. The method of claim 18, wherein the base layer comprises high definition (HD) or (SD) video, and wherein the enhancement layer comprises added content data layer to render ultra-high definition (UHD) video.

20. An apparatus, comprising:
means for receiving first service layer metadata from a first communication channel and second service layer metadata from a second communication channel; and
means for determining a plurality of services available from the first communication channel and the second communication channel based, at least in part, on the first service layer metadata and the second service layer metadata, wherein at least one of the plurality of services is a multiple channel service that comprises data in a pooled set of the first communication channel and the second communication channel, and wherein the multiple channel service is identified by examining service layer metadata of the plurality of services for a first service from the first service layer metadata matching a second service from the second service layer metadata.

21. The apparatus of claim 20, wherein the pooled set of the first communication channel and the second communication channel comprises a split of a baseband packet stream of the multiple channel service among two physical layer pipes on the first communication channel and the second communication channel.

22. The apparatus of claim 20, further comprising means for matching the first service and the second service by detecting a same service layer service attribute in both the first communication channel and the second communication channel.

23. The apparatus of claim 22, wherein the means for detecting a same service layer service attribute in both the first communication channel and the second communication channel comprises means for detecting a different BSID and detecting a same at least one other service layer service attribute.

24. The apparatus of claim 22, wherein the first communication channel comprises a baseband packet stream of the first service and the second communication channel comprises a baseband packet stream of the second service, and wherein a multiple tuner receiving device is operable to make any or all of the first service, the second service, and the multiple channel service available to a user at a same instant in time based at least in part on the service layer service attribute.

25. The apparatus of claim 24, wherein a single tuner receiving device is operable to make either the first service or the second service available to a user at an instant in time, and wherein the single tuner receiving device is operable to not make a third service available to the user at the instant in time based at least in part on the service layer service attribute.

26. The apparatus of claim 20, wherein the pooled set of the first communication channel and the second communication channel is provided at a physical layer using a Plain Channel Bonding protocol.

27. The apparatus of claim 20, wherein the multiple channel service is made available to a multiple tuner receiving device in the first communication channel and the second communication channel without affecting reception, by a single tuner receiving device, of the first service in the first communication channel or the second service of the second communication channel.

28. The apparatus of claim 27, wherein a channel capacity of a combination of the first communication channel and the second communication channel is larger than a channel capacity of the first communication channel and the second communication channel separately.

29. The apparatus of claim 20, wherein the pooled set of the first communication channel and second communication channel is formed by combining a first RF representation of the first communication channel and a second RF representation of the second communication channel.

30. The apparatus of claim 29, further comprising means for detecting the pooled set of the first communication channel and second communication channel by detecting duplication of service layer data with respect to the multiple channel service in both the first communication channel and the second communication channel.

31. The apparatus of claim 30, wherein the pooled set of the first communication channel and second communication channel is implemented at a physical layer, and wherein detecting the multiple channel service uses the duplication of service layer data with respect to the multiple channel service without using physical layer data.

32. The apparatus of claim 30, wherein the multiple channel service is also available by receiving either the first or second communication channels.

33. The apparatus of claim 30, wherein the first communication channel comprises a first RF representation of a portion of the multiple channel service and the second communication channel comprises a second RF representation of a portion of the multiple channel service, wherein a multiple tuner receiving device is operable to make the multiple channel service available to a user from data received from the first communication channel, the second communication channel, or the pooled set of the first communication channel and second communication channel.

34. The apparatus of claim 33, wherein a single tuner receiving device is operable to make the multiple channel service available to a user from data received from the first communication channel or the second communication channel alone.

35. The apparatus of claim 29, wherein a multiple tuner received device is operable to switch between the first communication channel and the second communication channel of the multiple channel service when a failure of one of the first communication channel or the second communication channel occurs.

36. The apparatus of claim 29, wherein the pooled set of the first communication channel and second communication channel is provided at a physical layer using a SNR Bonding method.

37. The apparatus of claim 20, wherein the pooled set of the first communication channel and the second communication channel comprises a split of a media stream of the multiple channel service, wherein first data of the first communication channel of the multiple channel service is a base layer, and wherein second data of the second communication channel of the multiple channel service is an enhancement layer.

38. The apparatus of claim 37, wherein the base layer comprises high definition (HD) or (SD) video, and wherein the enhancement layer comprises added content data layer to render ultra-high definition (UHD) video.

39. A computer program product, comprising:
a non-transitory computer readable medium comprising code to perform steps comprising:
receiving first service layer metadata from a first communication channel and second service layer metadata from a second communication channel; and
determining a plurality of services available from the first communication channel and the second communication channel based, at least in part, on the first service layer metadata and the second service layer metadata, wherein at least one of the plurality of services is a multiple channel service that comprises data in a pooled set of the first communication channel and the second communication channel, and wherein the multiple channel service is identified by examining service layer metadata of the plurality of services for a first service from the first service layer metadata matching a second service from the second service layer metadata.

40. The computer program product of claim 39, wherein the pooled set of the first communication channel and the second communication channel comprises a split of a baseband packet stream of the multiple channel service among two physical layer pipes on the first communication channel and the second communication channel.

41. The computer program product of claim 39, wherein the medium further comprises code to perform steps comprising matching the first service and the second service by detecting a same service layer service attribute in both the first communication channel and the second communication channel.

42. The computer program product of claim 41, wherein detecting a same service layer service attribute in both the first communication channel and the second communication channel comprises detecting a different BSID and detecting a same at least one other service layer service attribute.

43. The computer program product of claim 41, wherein the first communication channel comprises a baseband packet stream of the first service and the second communication channel comprises a baseband packet stream of the second service, and wherein a multiple tuner receiving device is operable to make any or all of the first service, the second service, and the multiple channel service available to a user at a same instant in time based at least in part on the service layer service attribute.

44. The computer program product of claim 43, wherein a single tuner receiving device is operable to make either the first service or the second service available to a user at an instant in time, and wherein the single tuner receiving device is operable to not make a third service available to the user at the instant in time based at least in part on the service layer service attribute.

45. The computer program product of claim 39, wherein the pooled set of the first communication channel and the second communication channel is provided at a physical layer using a Plain Channel Bonding protocol.

46. The computer program product of claim 39, wherein the multiple channel service is made available to a multiple tuner receiving device in the first communication channel and the second communication channel without affecting reception, by a single tuner receiving device, of the first service in the first communication channel or the second service of the second communication channel.

47. The computer program product of claim 46, wherein a channel capacity of a combination of the first communication channel and the second communication channel is larger than a channel capacity of the first communication channel and the second communication channel separately.

48. The computer program product of claim 39, wherein the pooled set of the first communication channel and second communication channel is formed by combining a first RF representation of the first communication channel and a second RF representation of the second communication channel.

49. The computer program product of claim 48, wherein the medium further comprises code to perform steps comprising detecting the pooled set of the first communication channel and second communication channel by detecting duplication of service layer data with respect to the multiple channel service in both the first communication channel and the second communication channel.

50. The computer program product of claim 49, wherein the pooled set of the first communication channel and second communication channel is implemented at a physical layer, and wherein detecting the multiple channel service uses the duplication of service layer data with respect to the multiple channel service without using physical layer data.

51. The computer program product of claim 49, wherein the multiple channel service is also available by receiving either the first or second communication channels.

52. The computer program product of claim 49, wherein the first communication channel comprises a first RF representation of a portion of the multiple channel service and the second communication channel comprises a second RF representation of a portion of the multiple channel service, wherein a multiple tuner receiving device is operable to make the multiple channel service available to a user from data received from the first communication channel, the second communication channel, or the pooled set of the first communication channel and second communication channel.

53. The computer program product of claim 49, wherein a single tuner receiving device is operable to make the multiple channel service available to a user from data received from the first communication channel or the second communication channel alone.

54. The computer program product of claim 48, wherein a multiple tuner received device is operable to switch between the first communication channel and the second communication channel of the multiple channel service when a failure of one of the first communication channel or the second communication channel occurs.

55. The computer program product of claim 48, wherein the pooled set of the first communication channel and second communication channel is provided at a physical layer using a SNR Bonding method.

56. The computer program product of claim 39, wherein the pooled set of the first communication channel and the second communication channel comprises a split of a media stream of the multiple channel service, wherein first data of the first communication channel of the multiple channel service is a base layer, and wherein second data of the second communication channel of the multiple channel service is an enhancement layer.

57. The computer program product of claim 56, wherein the base layer comprises high definition (HD) or (SD) video, and wherein the enhancement layer comprises added content data layer to render ultra-high definition (UHD) video.

58. An apparatus, comprising:
a memory; and
a processor coupled to the memory and configured to perform steps comprising:
receiving first service layer metadata from a first communication channel and second service layer metadata from a second communication channel; and
determining a plurality of services available from the first communication channel and the second communication channel based, at least in part, on the first service layer metadata and the second service layer metadata, wherein at least one of the plurality of services is a multiple channel service that comprises data in a pooled set of the first communication channel and the second communication channel, and wherein the multiple channel service is identified by examining service layer metadata of the plurality of services for a first service from the first service layer metadata matching a second service from the second service layer metadata.

59. The apparatus of claim 58, wherein the pooled set of the first communication channel and the second communication channel comprises a split of a baseband packet stream of the multiple channel service among two physical layer pipes on the first communication channel and the second communication channel.

60. The apparatus of claim 58, wherein the processor is further configured to perform steps comprising matching the first service and the second service by detecting a same service layer service attribute in both the first communication channel and the second communication channel.

61. The apparatus of claim 60, wherein detecting a same service layer service attribute in both the first communication channel and the second communication channel comprises detecting a different BSID and detecting a same at least one other service layer service attribute.

62. The apparatus of claim 60, wherein the first communication channel comprises a baseband packet stream of the first service and the second communication channel comprises a baseband packet stream of the second service, and wherein a multiple tuner receiving device is operable to make any or all of the first service, the second service, and the multiple channel service available to a user at a same instant in time based at least in part on the service layer service attribute.

63. The apparatus of claim 62, wherein a single tuner receiving device is operable to make either the first service or the second service available to a user at an instant in time, and wherein the single tuner receiving device is operable to not make a third service available to the user at the instant in time based at least in part on the service layer service attribute.

64. The apparatus of claim 58, wherein the pooled set of the first communication channel and the second communication channel is provided at a physical layer using a Plain Channel Bonding protocol.

65. The apparatus of claim 58, wherein the multiple channel service is made available to a multiple tuner receiving device in the first communication channel and the second communication channel without affecting reception, by a single tuner receiving device, of the first service in the first communication channel or the second service of the second communication channel.

66. The apparatus of claim 65, wherein a channel capacity of a combination of the first communication channel and the second communication channel is larger than a channel capacity of the first communication channel and the second communication channel separately.

67. The apparatus of claim 58, wherein the pooled set of the first communication channel and second communication channel is formed by combining a first RF representation of the first communication channel and a second RF representation of the second communication channel.

68. The apparatus of claim 67, wherein the processor is further configured to perform steps comprising detecting the pooled set of the first communication channel and second communication channel by detecting duplication of service layer data with respect to the multiple channel service in both the first communication channel and the second communication channel.

69. The apparatus of claim 68, wherein the pooled set of the first communication channel and second communication channel is implemented at a physical layer, and wherein detecting the multiple channel service uses the duplication of service layer data with respect to the multiple channel service without using physical layer data.

70. The apparatus of claim 69, wherein the multiple channel service is also available by receiving either the first or second communication channels.

71. The apparatus of claim 69, wherein the first communication channel comprises a first RF representation of a portion of the multiple channel service and the second communication channel comprises a second RF representation of a portion of the multiple channel service, wherein a multiple tuner receiving device is operable to make the multiple channel service available to a user from data received from the first communication channel, the second communication channel, or the pooled set of the first communication channel and second communication channel.

72. The apparatus of claim 71, wherein a single tuner receiving device is operable to make the multiple channel service available to a user from data received from the first communication channel or the second communication channel alone.

73. The apparatus of claim 67, wherein a multiple tuner received device is operable to switch between the first communication channel and the second communication channel of the multiple channel service when a failure of one of the first communication channel or the second communication channel occurs.

74. The apparatus of claim 67, wherein the pooled set of the first communication channel and second communication channel is provided at a physical layer using a SNR Bonding method.

75. The apparatus of claim 58, wherein the pooled set of the first communication channel and the second communication channel comprises a split of a media stream of the multiple channel service, wherein first data of the first communication channel of the multiple channel service is a base layer, and wherein second data of the second communication channel of the multiple channel service is an enhancement layer.

76. The apparatus of claim 75, wherein the base layer comprises high definition (HD) or (SD) video, and wherein the enhancement layer comprises added content data layer to render ultra-high definition (UHD) video.
